(19) United States
(12) Patent Application Publication
(10) Pub. No.: US 2007/0088496 A1
(43) Pub. Date: Apr. 19, 2007

(54) Automatic heading and reference system

(75) Inventor: Daniel J. Preston, Kew Gardens, NY (US)

Correspondence Address: BOURQUE & ASSOCIATES;INTELLECTUAL PROPERTY ATTORNEYS, P.A., 835 HANOVER STREET, SUITE 301, MANCHESTER, NH, 03104, US

(73) Assignee: Atair Aerospace, Inc., Brooklyn, NY (US)

(21) Appl. No.: 11/185,410

(22) Filed: Jul. 20, 2005

(51) Int. Cl. G01C 21/00

(52) U.S. Cl. 701/207

(57) ABSTRACT

A sensor system and method is disclosed which is substantially non-shock sensitive, inexpensive and small enough to be incorporated into most applications. The sensor system includes a magnetometer (preferably a triaxial magnetometer) and at least one infrared sensor. In the preferred embodiment, the sensor system includes at least four infrared sensors arranged substantially orthogonal to each other in a common plane horizontal to the earth's surface. The infrared sensors generate signals that are analyzed by a processor to determine the tilt orientation of the object. Based on the tilt orientation of the object, the magnetometer is tilt compensated (preferably fully compensated). The sensor system may also include a global positioning system.

### CROSS-REFERENCE TO RELATED APPLICATIONS

This application claims the benefit of U.S. Provisional Application No. 60/568,540, filed May 5, 2004.

### TECHNICAL FIELD

The present invention relates to aircraft attitude and orientation control systems and more particularly, relates to a non-shock sensitive sensor system for determining the orientation of an aircraft.

### BACKGROUND INFORMATION

Sensor systems for controlling aircraft and spacecraft are well known to those skilled in the art. While there exists a variety of different systems, one of the most common types of automatic heading and reference systems for aircraft uses an array of three (3) orthogonal accelerometers, three (3) gyroscopes, and/or magnetometers. These sensors are coupled to a processor and software that interprets the signals produced by the various sensors to determine the three orthogonal axes (lateral X (pitch), longitudinal Y (roll), and vertical Z (yaw)).

While these known systems are generally accurate, they suffer from several disadvantages. One disadvantage of the know systems is that they are expensive, technically complex and physically large and heavy. This makes them unsuitable for a variety of applications including, but not limited to, guided weapons and delivery platforms that are rocket or mortar fired.

Another disadvantage of the known sensor systems is that they are shock sensitive. During launching, rocket or mortar fired platforms can experience acceleration forces of 15,000 g's or more which is at or above the limit of most state of the art inertial sensors. These extreme acceleration forces often overload the sensor systems, causing the sensor systems to stop working, output erroneous data or worse, fail all together. Moreover, the systems that are capable of withstanding these forces are not small enough or economical enough to be of any practical use in many applications.

Accordingly, there exists a need to incorporate a non-shock-sensitive sensor block into rocket or motor fire guided weapons and delivery platforms. The sensor system should be capable of operating during rocket or mortar fired launches and acceleration forces of 15,000 g's or more. Moreover, the sensor system should be small enough and economical enough to be used in a multitude of applications.

It is important to note that the present invention is not intended to be limited to a system or method which must satisfy one or more of any stated objects or features of the invention. It is also important to note that the present invention is not limited to the preferred, exemplary, or primary embodiment(s) described herein. Modifications and substitutions by one of ordinary skill in the art are considered to be within the scope of the present invention, which is not to be limited except by the following claims.

### SUMMARY

According to one embodiment, the present invention features a method of tilt compensating a magnetometer. At least three magnetometers arranged substantially orthogonal to each other may be provided. Alternatively, one or more triaxial magnetometers may be provided.

The method includes the acts of receiving a first and a second signal from an infrared sensor. Next, a difference between the first and second signal is calculated and the tilt of the magnetometer is determined based on the difference between the first and the second signal. Once the tilt of the magnetometer is known, the magnetometer is tilt compensated.

In one embodiment, a single infrared sensor generates the first and the second signal. Alternatively, a first and at least a second infrared sensor generate the first and the second signals, respectively. Four or more infrared sensors may be arranged substantially 90 degrees apart in substantially parallel plane to each other. In the preferred embodiment, at least two infrared sensors are directed substantially towards the ground and at least two infrared sensors are directed towards the sky.

According to another embodiment, the present invention features a system for determining an orientation of an object. The system includes at least one magnetometer secured and at least one infrared sensor to the object. The system may include at least three magnetometers arranged substantially orthogonal to each other or alternatively may includes a triaxial magnetometer. A processor is coupled to both the magnetometer and the infrared sensors. The processor compares an output signal generated by the infrared sensor to determine a tilt of the magnetometer. Based on the tilt of the magnetometer, the processor tilt compensates the magnetometer.

The system preferably includes at least four infrared sensors directed substantially 90 degrees apart in substantially parallel plane to each other. At least two of the infrared sensors are directed substantially towards the earth and at least two of the infrared sensors are directed towards the sky. Alternatively, the system may include eight infrared sensors. Two of the infrared sensors are directed in each of the four directions wherein the first infrared sensor is directed substantially towards the earth at approximately a 45-degree angle from the horizon and the second infrared sensor is directed substantially towards the sky at approximately a 45-degree angle from the horizon.

The system may also include at least one of the following sensors selected from the group consisting of accelerometers and gyroscopes. Switching software running on the processor determines at least one of the available sensors which is most appropriate given the operating conditions and selects the most appropriate sensor(s). Optionally, a global positioning system may be coupled to the processor.

### BRIEF DESCRIPTION OF THE DRAWINGS

These and other features and advantages of the present invention will be better understood by reading the following detailed description, taken together with the drawings wherein:

FIG. 1 is a top plan view showing one embodiment of the sensor system secured to an aircraft;

FIG. 2 is a top plan view showing another embodiment of the sensor system secured to an aircraft;

FIG. 3 is a side perspective view of the infrared thermopile sensors shown in FIG. 2 according to the present invention;

FIG. 4 is a top plan view showing a further embodiment of the sensor system secured to an aircraft;

FIG. 5 is a flow chart illustrating one embodiment of the method according to the present invention; and

FIG. 6 is a block diagram of one embodiment of the sensor system according to the present invention.

### DETAILED DESCRIPTION OF THE PREFERRED EMBODIMENTS

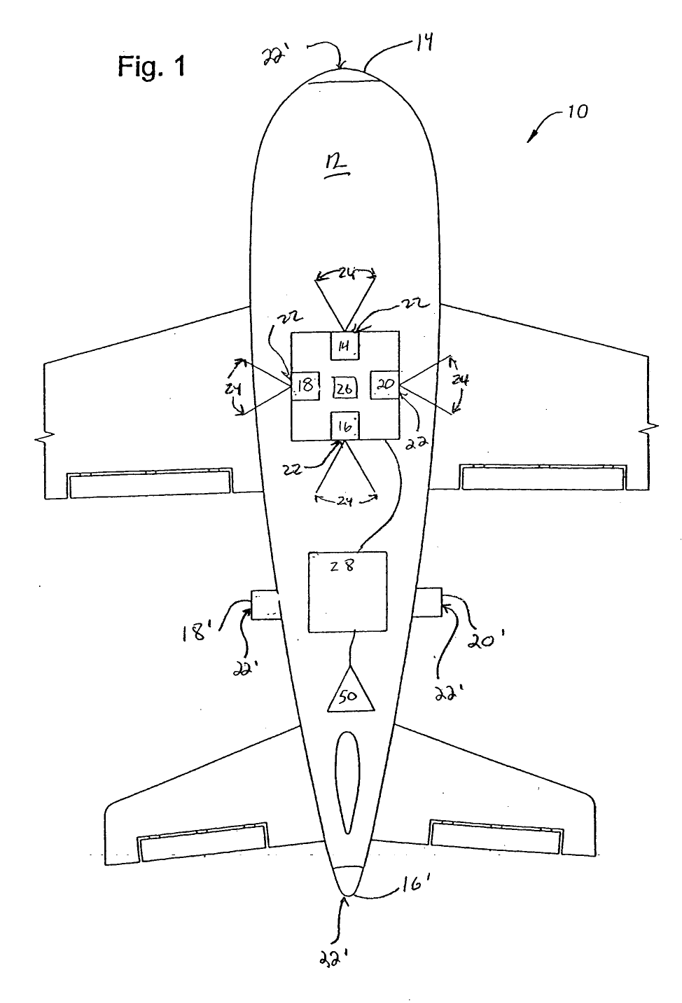

According to one embodiment, the present invention features a non-shock sensitive sensor system and method 10, FIG. 1, secured to an object 12 for determining orientation, heading, and/or reference of the object 12. The sensor system and method 10 will be described and illustrated with respect a fixed wing aircraft 12, however, this is not a limitation of the present invention unless specifically recited as such in the accompanying claims. Those skilled in the art will readily recognize that the sensor system and method 10 according to the present invention is application for numerous objects including, but not limited to, rockets, mortars, spacecraft, satellites, balloons, helicopters, motorized and non-motorized hang gliders, motorized and non-motorized parasails, hovercrafts, nautical vessels, model aircrafts, launching platforms, other types of aircraft, torpedoes, automobiles, and the like.

As will be explained in greater detail hereinbelow, the sensor system and method 10 according to the present invention is non-shock sensitive. Accordingly, the acceleration forces generated during the launching of rockets, mortars, and delivery platforms using the same will not adversely affect the sensor system and method 10. Additionally, the sensor system and method 10 is compact enough and economical enough to be used with non-returning objects.

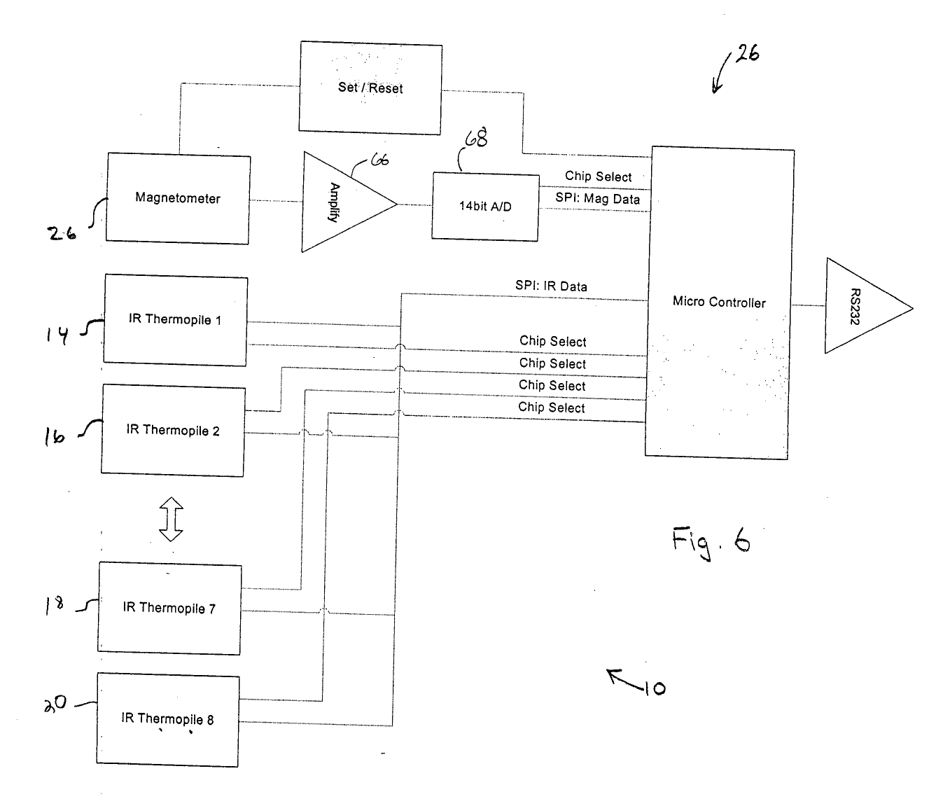

According to one embodiment, the sensor system and method 10, FIGS. 1 and 6, includes at least four infrared thermopile sensors 14-20 directed substantially 90° apart from each other in substantially the same plane. In the exemplary embodiment, the plane in which the infrared thermopile sensors 14-20 are arranged is the plane of the aircraft 12 parallel to the earth's surface when the aircraft 12 is in level flight (neutral pitch and roll). It is important to note that the infrared thermopile sensors 14-20 do not have to be all located in the same plane.

Each of the infrared thermopile sensors 14-20 includes infrared light receptors 22 for receiving the infrared electromagnetic radiation signals. In the preferred embodiment, all infrared thermopile sensors 14-20 are mounted within the frame of aircraft 12, and infrared light receptors 26 are oriented through an opening in the aircraft frame or through a material that is transparent to infrared electromagnetic radiation.

While the infrared thermopile sensors 14-20 are shown grouped together, the infrared thermopile sensors 14-20 may alternatively be located apart from each other. While there are virtually an unlimited number of possible sensor layout arrangements, the infrared thermopile sensors 14′-20′ may be located on the nose section, tail section, and left/right fuselage sections respectively. Regardless of the location of the infrared thermopile sensors 14-20, it is important that the infrared thermopile sensors 14-20 are arranged to avoid engine heat signatures as well as other sources of erroneous heat signatures.

The infrared thermopile sensors 14-20 preferably have generally conical fields of view 24 and measure the difference in thermal temperature between sky and the ground. It is important to note that a measurable difference in the thermal temperature between the sky and the ground exists in virtually all conditions, night or day. For exemplary purposes only, the infrared thermopile sensors 14-20 may include a MLX9060 family infrared thermometer module (such as, but not limited to a MLX90601KZA-BKA infrared thermometer module) produced by Melexis Microelectronic Systems or a TPMI discrete thermopile produced by PerkinElmer Optoelectronics.

The sensor system and method 10 also includes three orthogonal magnetometers (or one triaxial magnetometer) 26. For exemplary purposes only, the magnetometer 26 may include a HMC1053 3-axis magnetometer by Honeywell. As is well known to those skilled in the art, the magnetometer 26 is capable of determining the exact position of the aircraft 12 provided the orientation of the aircraft 12 does not change. Unfortunately, if the aircraft 12 is tilted, then the magnetometer 26 needs to be recalibrated/compensated for the tilt.

The magnetometer 26 is used to determine the x, y, and z components of the aircraft 12. The output of the magnetometer 26 is preferably amplified by amplifier 66 (FIG. 6) and is sent through an A/D 68 (FIG. 6) to the microcontroller 26. The x, y, and z components are used to determine a magnetic field vector as is well known to those skilled in the art. As will be explained in greater detail hereinbelow, the infrared thermopile sensors 14-20 according to the present invention are used to tilt compensate (preferably fully compensate) the magnetometers 26 in order to derive an accurate heading (yaw).

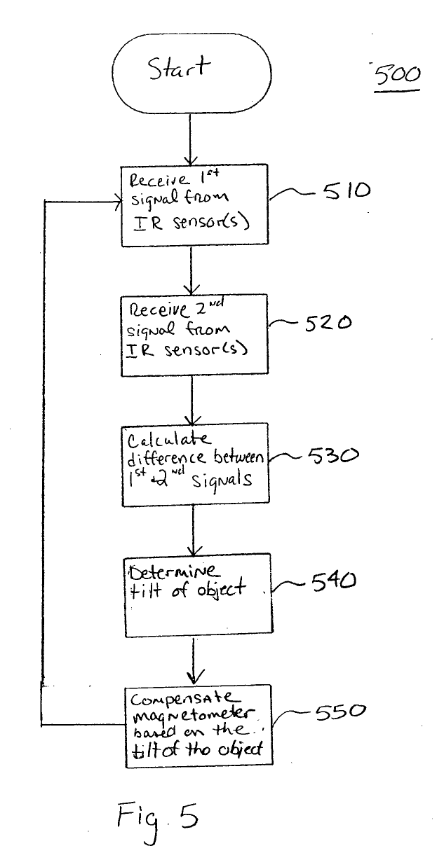

The sensor system and method 10 begins by receiving a first signal from an infrared thermopile sensor(s), act 510, FIG. 5. Additionally, a second signal is received from the infrared thermopile sensor(s), act 520, and the difference between the signals is calculated, act 530. Based on the difference in the signal, the tilt of the aircraft is determined, act 540. Based on the tilt of the aircraft, the magnetometer is tilt compensated, act 550. The method 500 is then preferably repeated.

For example, when the aircraft 12 is level with the horizon, all the infrared thermopile sensors 14-20 are in the same plane and the output signals of the infrared thermopile sensors 14-20 are all equal. A processor 28 containing an algorithm and/or software is coupled to the infrared thermopile sensors 14-20. The processor 28 receives the output signals generated by the infrared thermopile sensors 14-20 and interprets the difference in thermal temperature (in this case, no difference) to calculate the tilt of the aircraft 12 (again, in this case the aircraft is level).

When the aircraft 12 is tilted with respect to pitch and/or roll, one or more infrared thermopile sensors 14-20 points above the horizon line towards the sky and the opposite infrared thermopile sensors 14-20 will point below the horizon line towards the ground. For exemplary purposes only, when the aircraft 12 rolls left, the left infrared thermopile sensor 18 will point towards the earth while the right infrared thermopile sensor 20 will point towards the sky. The infrared thermopile sensors 18, 20 then measure the difference in thermal temperature between the sky and ground and the processor 28 interprets the difference in thermal temperature to calculate the tilt of the aircraft 12. Once the tilt of the aircraft 12 is known, the magnetometers 26 can be corrected.

The sensor system and method 10 may also include a global positioning system (GPS) 50 coupled to the processor 28. The GPS 50 receives positioning data as is well known to those skilled in the art. The sensor system and method 10 uses the infrared thermopile sensors 14-20 to determine the heading as well as the position of the aircraft 12. Using this information, the processor 28 can function as an inertial navigation system.

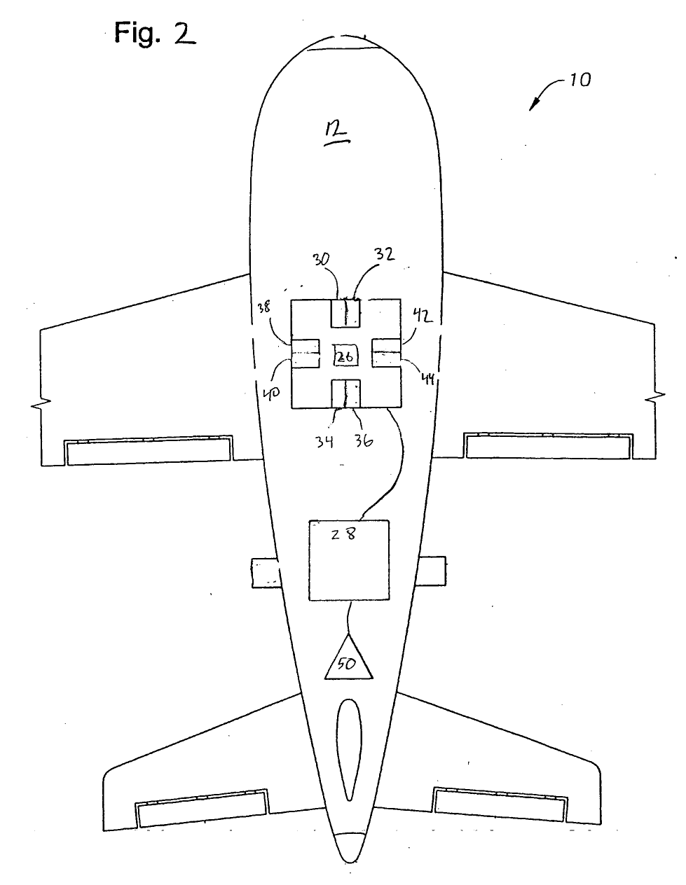

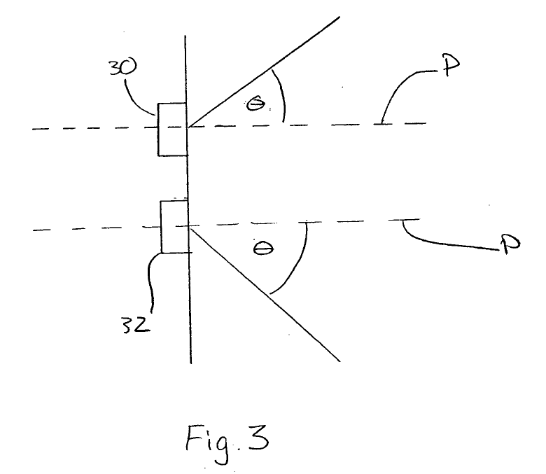

According to another embodiment of the present invention, the sensor system and method 10, FIG. 2, includes a magnetometer 26 as described above and more than four infrared thermopile sensors (preferably eight infrared thermopile sensors) 30-44. According to this embodiment, two or more infrared thermopile sensors 30-44 are arranged in each of the four positions. As best shown in FIG. 3, the preferred embodiment includes two infrared thermopile sensors 30, 32 orientated at angles ?? approximately 45 degrees from the horizontal plane P. This arrangement increases the accuracy of the sensor system and method 10 by providing four infrared thermopile sensors 30-44 for pitch and four infrared thermopile sensors 30-44 for roll. While the preferred embodiment utilizes eight infrared thermopile sensors 30-44, this is not a limitation of the present invention and more or less infrared thermopile sensors 30-44 may be utilized.

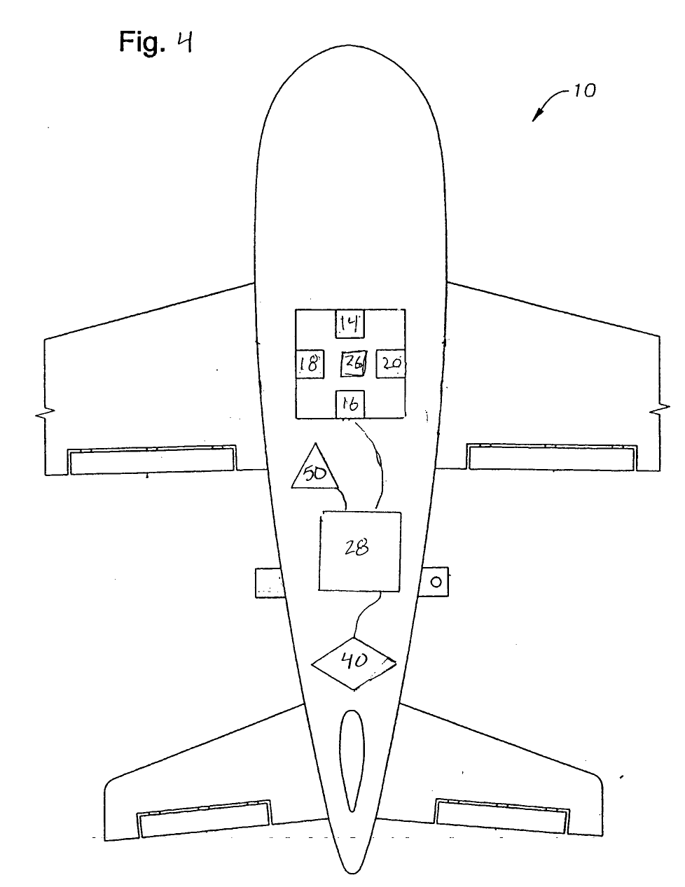

According to yet another embodiment of the present invention, the sensor system and method 10, FIG. 4, includes a plurality of infrared thermopile sensors 14-20 and a magnetometer 26 as described above, as well as one or more of the following sensors: orthogonal accelerometer, gyroscopes (gyros) and/or magnetometers, collectively referred to as supplemental sensors 40. Preferably, the sensor system and method 10 includes an array of three (3) of each of the foregoing supplemental sensors 40.

The processor 28 of the sensor systems 10 also includes software that selectively switches between the supplemental sensors 40 and the infrared thermopile sensors 14-20. The processes 28 determines when either the supplemental sensors 40 and/or the infrared thermopile sensors 14-20 are most appropriate and selects either one or more of the sensors which would be advantageous. For example, during instances where acceleration forces would either damage or over range supplemental sensors 40 (for example, but not limited to, a launch or an emanate launch), the processor 28 would select only the infrared thermopile sensors 14-20. However, during normal flight the processor 28 might select the supplemental sensors 40 and optionally the infrared thermopile sensors 14-20. Furthermore, in known instances wherein either the supplemental sensors 40 or the infrared thermopile sensors 14-20 might generate erroneous data (for example, when flying over a land/water interface), the processor 28 would select the most reliable sensors. The software running on the processor 28 may also switch gains on the supplemental sensors 40, and/or make calibrations off of the infrared thermopile sensors 14-20.

An additional advantage of some embodiments of sensor system and method 10 according to the present invention is that the sensor system and method 10 and method are ideal for use on spinning objects (e.g., a spinning projectile or autorotating helicopter airdrop payload). In such situations, with rotations of 900 RPM or more, typical existing inertial measurement is not practical or functional. The sensor system and method 10 according to the present invention simply generates sine wave outputs (from the infrared thermopile sensors 14-20) that may then be easily understood by the processor 28. According to this embodiment, the sensor system and method 10 may include only a single infrared thermopile sensor 14, but preferably includes at least two infrared thermopile sensors 14, 16. Furthermore, such embodiments may optionally contain no accelerometers or gyros to be effected by the rotation.

Accordingly, embodiments of the invention are directed to inertial sensor systems that are substantially non-shock sensitive, inexpensive and small enough to be incorporated into guided platforms. As mentioned above, the present invention is not intended to be limited to a system or method which must satisfy one or more of any stated or implied object or feature of the invention and should not be limited to the preferred, exemplary, or primary embodiment(s) described herein. The foregoing description of a preferred embodiment of the invention has been presented for purposes of illustration and description. It is not intended to be exhaustive or to limit the invention to the precise form disclosed. Obvious modifications or variations are possible in light of the above teachings. The embodiment was chosen and described to provide the best illustration of the principles of the invention and its practical application to thereby enable one of ordinary skill in the art to utilize the invention in various embodiments and with various modifications as is suited to the particular use contemplated. All such modifications and variations are within the scope of the invention as determined by the claims when interpreted in accordance with breadth to which they are fairly, legally and equitably entitled.

The invention claimed is:

1. A method of tilt compensating a magnetometer comprising the acts of:
receiving a first signal from an infrared sensor;
receiving at least a second signal from said infrared sensor;
calculating a difference between said first and said at least a second signal;
determining a tilt of said magnetometer based on said difference between said first and said at least a second signal; and
tilt compensating said magnetometer based on said tilt of said magnetometer.

2. The method as claimed in claim 1 wherein said method includes:
receiving a first signal from a first infrared sensor; and
receiving at least a second signal from at least a second infrared sensor.

3. The method as claimed in claim 2 further including at least four infrared sensors directed substantially 90 degrees apart in substantially parallel plane to each other.

4. The method as claimed in claim 3 wherein said at least two infrared sensors are directed substantially towards the ground and at least two infrared sensors are directed towards the sky.

5. The method as claimed in claim 1 wherein said first and said at least a second signal are generated by a single infrared sensor.

6. The method as claimed in claim 1 wherein said magnetometer includes at least three magnetometers arranged substantially orthogonal to each other.

7. The method as claimed in claim 1 wherein said magnetometer includes a triaxial magnetometer.

8. The method as claimed in claim 1 wherein said magnetometer includes at least three magnetometers arranged substantially orthogonal to each other.

9. A system for determining an orientation of an object comprising:
at least one magnetometer secured to said object;
at least one infrared sensor secured to said object; and
a processor, said processor comparing an output signal generated by said at least one infrared sensor to determine a tilt of said sensor, wherein said processor tilt compensates said at least one magnetometer in response to said tilt of said object.

10. The system as claimed in claim 9 wherein said at least one magnetometer includes at least three magnetometers arranged substantially orthogonal to each other.

11. The method as claimed in claim 9 wherein said at least one magnetometer includes at least one triaxial magnetometer.

12. The system as claimed in claim 9 wherein said at least one infrared sensor includes at least four infrared sensors directed substantially 90 degrees apart in substantially parallel planes to each other.

13. The system as claimed in claim 12 wherein at least two of said infrared sensors are directed substantially towards the earth and at least two of said infrared sensors are directed towards the sky.

14. The system as claimed in claim 12 wherein further including eight infrared sensors wherein two infrared sensors are directed in each of the four directions, and wherein each of said four directions includes a first infrared sensor directed substantially towards the earth at approximately a 45 degree angle from the horizon and wherein a second infrared sensors is directed substantially towards the sky at approximately a 45 degree angle from the horizon.

15. The system as claimed in claim 9 further including at least one of the following sensors selected from the group consisting of accelerometers and gyroscopes.

16. The system as claimed in claim 15 wherein said processor further includes switching software, wherein said switching software determines at least one of the available sensors which is most appropriate given the operating conditions and selects said at least one appropriate sensor.

17. The system as claimed in claim 9 further including a global positioning system coupled to said processor.

18. A system for determining an orientation of an object comprising:
at least four infrared sensors secured to said object, said at least four infrared sensors directed substantially 90 degrees apart in substantially parallel planes to each other;
a triaxial magnetometer secured to said object; and
a processor coupled to said at least four infrared sensors and said triaxial magnetometer, said processor receiving output signals from said at least four infrared sensors and calculating a tilt of said object based on a difference between said signals and compensating said magnetometer based on said calculated tilt.

19. The system as claimed in claim 18 further including a global positioning system coupled to said processor.

20. The system as claimed in claim 18 further including at least one of the following sensors selected from the group consisting of accelerometers and gyroscopes, wherein said processor further includes switching software for determining at least one of the available sensors which is most appropriate given the operating conditions and for selecting said at least one appropriate sensor.
